(19) United States
(12) Patent Application Publication
(10) Pub. No.: US 2023/0215123 A1
(43) Pub. Date: Jul. 6, 2023

(54) INFORMATION PROCESSING APPARATUS, INFORMATION PROCESSING METHOD AND NON-TRANSITORY STORAGE MEDIUM STORING PROGRAM

(71) Applicant: Yukigumo Co., Ltd., Nagano-shi (JP)

(72) Inventor: Kenichiro MARUYAMA, Nagano-shi (JP)

(73) Assignee: Yukigumo Co., Ltd., Nagano-shi (JP)

(21) Appl. No.: 18/121,737

(22) Filed: Mar. 15, 2023

Related U.S. Application Data
(63) Continuation of application No. PCT/JP2021/034070, filed on Sep. 16, 2021.

(30) Foreign Application Priority Data
Sep. 16, 2020 (JP) 2020-155825

(51) Int. Cl. G06T 19/20; G06T 7/20; G06T 7/70; G06V 10/60; H04N 13/117; G06F 3/14

(52) U.S. Cl. CPC G06T 19/20; G06T 7/20; G06T 7/70; G06V 10/60; H04N 13/117; G06F 3/14; G06T 2219/2004; G06T 2219/2016

(57) ABSTRACT

An information processing apparatus forms a virtual space that is viewable by a user by using a display device, and includes an information acquirer configured to acquire information that causes at least one of movement of a position of the user and a change in an orientation of the user in the virtual space. The information processing apparatus includes a control circuit configured to output, to the display device, based on the information that is acquired, an image in which a scene being viewed by the user in the virtual space is changed in a predetermined time range.

### CROSS-REFERENCE TO THE RELATED APPLICATION

This application is a continuation application of International Application PCT/JP2021/034070 filed on Sep. 16, 2021, which claim priority to Japan Patent Application 2020-155825 filed on Sep. 16, 2020, and designated the U.S., the entire contents of each are incorporated herein by reference.

### BACKGROUND

### Technical Field

The present disclosure relates to an information processing apparatus, an information processing method, and a non-transitory storage medium storing a program.

### Description of the Related Art

A game system related to a virtual reality program described in Patent document 1 includes a head-mounted display that is mounted on a head of a player to cover a view of the player, an input reception device capable of detecting body movement of the player, and a computer.

### CITATION LIST

### Patent Document

[Patent document 1] Japanese Patent Laid-Open No 2019-005564

### Non Patent Document

[Non Patent document 1] Hiroyasu UJIKE, Mitsunori TADA, Keiichiro HYODO, S7-2 VR sickness while viewing images with HMD during head movement, Ergonomics, 2018, Vol. 54, Issue Supplement, p. S7-2, Jul. 10, 2018

### SUMMARY

According to Non Patent document 1, with introduction of head-mounted displays (hereinafter “HMD(s)”) into the commercial market in recent years, virtual reality and artificial reality (hereinafter “VR”) environments are generally becoming more and more familiar. On the other hand, motion sickness in the VR environment, or in other words, VR sickness may sometimes be caused. The present disclosure is aimed at providing an information processing apparatus and the like that prevent VR sickness in the VR environment.

An aspect of an embodiment of the present disclosure may be illustrated as an information processing apparatus.

The information processing apparatus may form a virtual space that is viewable by a user by using a display device, and includes:

an information acquirer configured to acquire information that causes at least one of movement of a position of the user and a change in an orientation of the user in the virtual space; and

a control circuit configured to output, to the display device, based on the information that is acquired, an image in which a scene being viewed by the user in the virtual space is changed in a predetermined time range.

In another aspect of the embodiment of the present disclosure, the information processing apparatus may form a virtual space that is viewable by a user by using a display device, and includes:

an information acquirer configured to acquire information that causes at least one of movement of a position of the user and a change in an orientation of the user in the virtual space; and

a control circuit configured to form an image based on the information that is acquired, in such a way that a movement destination in a movement direction of a line of sight of the user in the virtual space is brighter relative to a movement origin, and to output the image to the display device.

Another aspect of the embodiment of the present disclosure is also illustrated as an information processing method that may be performed by at least one computer such as the information processing apparatus described above.

Further another aspect of the embodiment of the present disclosure is also illustrated as a non-transitory storage medium storing a program that may be executed by at least one computer such as the information processing apparatus described above.

As described above, the present disclosure is capable of providing an information processing apparatus and the like that prevent VR sickness in the VR environment.

### BRIEF DESCRIPTION OF THE DRAWINGS

FIG. 1 is a block diagram of an information processing apparatus according to the present disclosure.

FIG. 2 is a transition diagram for a movement direction of a user, according to Example 1 of the present disclosure.

FIG. 3 is a transition diagram for a viewpoint direction of the user, according to Example 1 of the present disclosure.

FIG. 4 is a transition diagram for images that are output, according to Example 1 of the present disclosure.

FIG. 5 is a diagram illustrating an example where the user changes the movement direction in a height direction, according to Example 1 of the present disclosure.

FIG. 6 is a diagram illustrating an example image output for a case where the user turns right, according to Example 2 of the present disclosure.

FIG. 7 is a diagram illustrating an example image output for a case where the user turns left, according to Example 2 of the present disclosure.

FIG. 8 is a flowchart illustrating an example of a process, according to Example 1 of the present disclosure.

FIG. 9 is a flowchart illustrating a process, according to Example 2 of the present disclosure.

FIG. 10 is a transition diagram for the movement direction of the user, according to Example 3 of the present disclosure.

FIG. 11 is a flowchart illustrating an example of a process, according to Example 3 of the present disclosure.

FIG. 12 is a diagram illustrating a concept of coordinate interpolation at a time of movement of the user, according to Example 4 of the present disclosure.

FIG. 13 is a diagram illustrating a concept of interpolation at a time of direction change of the user, according to Example 4 of the present disclosure.

FIG. 14 is a flowchart illustrating an example of a process, according to Example 4 of the present disclosure.

### DESCRIPTION OF THE EMBODIMENTS

Hereinafter, an information processing apparatus and an information processing method according to an embodiment (also referred to as “Example”) of the present disclosure will be described with reference to the drawings.

### FIRST EXAMPLE

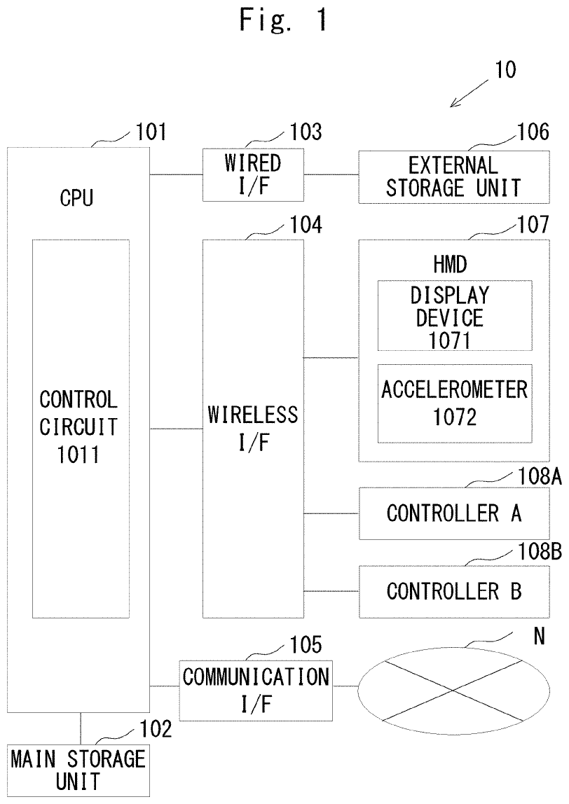

A first example (also referred to as “Example 1”) will be described with reference to FIGS. 1 to 5 and FIG. 8.

FIG. 1 is a block diagram illustrating a hardware configuration of an information processing apparatus according to the present example. An information processing apparatus 10 includes a central processing unit (CPU) 101, a main storage unit 102, and input/output components connected by various interfaces. The CPU 101 performs information processing based on a program stored in the main storage unit 102.

For example, the information processing apparatus 10 includes a wired interface (hereinafter “wired I/F”) 103, a wireless interface (hereinafter “wireless I/F”) 104, a communication interface (hereinafter “communication I/F”) 105, an external storage unit 106, a head-mounted display (hereinafter “HMD”) 107, and a controller A 108A and a controller B 108B. The information processing apparatus 10 here is an electronic appliance such as a personal computer, a game device, a smartphone, or a personal digital assistant, for example.

The CPU 101 includes a control circuit 1011, executes computer programs that are developed in the main storage unit 102 in an executable manner, and provides functions of the information processing apparatus 10. The CPU 101 may be multi-core, or may include a dedicated processor that performs signal processing or the like. The CPU 101 may include a dedicated hardware circuit that performs signal processing, multiplication-addition, vector calculation, or other processes.

The control circuit 1011 includes various processors such as a CPU, a micro processing unit (MPU), and a graphics processing unit (GPU). The control circuit 1011 includes a function of controlling the entire information processing apparatus 10.

The control circuit 1011 provides a virtual space to a display device 1071 of the HMD 107 by executing a predetermined application stored in the main storage unit 102 of the information processing apparatus 10 or in the external storage unit 106 connected via the wired I/F 103. The control circuit 1011 may thus cause the HMD 107 to perform an operation that allows a user to immerse himself/herself in a three-dimensional virtual space (VR space).

The main storage unit 102 stores computer programs to be executed by the CPU 101, data to be processed by the CPU 101, and the like. The main storage unit 102 includes a read only memory (ROM) and a volatile memory such as a random access memory (RAM), and temporarily stores programs to be used by the CPU 101 and control data such as calculation parameters. For example, the main storage unit 102 includes a main memory and a read only memory. The main storage unit 102 also includes a dynamic random access memory (DRAM) and a high-speed cache memory. At the time of operation and use, when processing data is stored in the main storage unit 102, the main storage unit 102 stores at least a part of instructions for execution by the CPU 101.

The information processing apparatus 10 may also include the external storage unit 106, in addition to the main storage unit 102. For example, the external storage unit 106 is used as a storage area for supplementing the main storage unit 102, and stores computer programs to be executed by the CPU 101, data to be processed by the CPU 101, and the like. The external storage unit 106 includes a non-volatile memory such as a flash memory, a disk drive such as a hard disk drive (HDD), or the like. The external storage unit 106 stores a user authentication program, game programs including data related to various images and objects, and the like. Furthermore, a database including a table for managing various data pieces may be constructed in the external storage unit 106.

The wired interface (hereinafter “wired I/F”) 103 transfers information between the CPU 101 and the external storage unit 106. Information to be transferred is information such as computer programs to be executed by the CPU 101 and data to be processed by the CPU 101, for example. The wired I/F 103 includes various connection terminals such as a universal serial bus (USB) terminal, a digital visual interface (DVI) terminal, and a high-definition multimedia interface (HDMI; registered trademark), and connects the CPU 101 to the external storage unit 106 and the like. The wired I/F 103 may also connect the CPU 101 to the HMD 107, the controller A 108A, and the controller B 108B.

The wireless interface (hereinafter “wireless I/F”) 104 wirelessly connects the CPU 101 to the HMD 107, the controller A 108A and the controller B 108B, and transfers information between the two. Information to be transferred is information that is detected by an accelerometer 1072 provided in the HMD 107, information input to the controller A 108A or the controller B 108B by a user, and information about an image that is generated by the control circuit 1011 and output to the HMD 107, for example. The wireless I/F 104 may also wirelessly connect the CPU 101 to the external storage unit 106, and transfer information between the two. The wireless I/F 104 is Bluetooth Low Energy (BLE; registered trademark), a wireless LAN or the like, for example. Additionally, the configuration in FIG. 1 is an example of the information processing apparatus 10, and the information processing apparatus 10 in Example 1 and Examples 2 to 4 described later is not limited to the configuration in FIG. 1. For example, one or some or all of the HMD 107, the controller A 108A and the controller B 108B may be connected to the CPU 101 via the wired I/F 103. The CPU 101 is capable of performing processes illustrated in Examples 1 to 4 also when one or some or all of the HMD 107, the controller A 108A and the controller B 108B are connected to the CPU 101 via the wired I/F 103.

The communication interface (hereinafter “communication I/F”) 105 transmits/receives data from other devices via a network N. For example, the communication I/F 105 is a communication device of a terminal that is capable of connecting to a base station of a mobile phone network. The communication I/F 105 may include an interface to a wireless local area network (LAN), or an interface for Bluetooth (registered trademark) or Bluetooth Low Energy (BLE; registered trademark).

The HMD 107 may be of a type such as “non-see-through” or “see-through” that is worn over both eyes to completely cover the eyes, but instead, the HDM 107 may be worn over one eye. In the present example, the HMD 107 includes the display device 1071 and the accelerometer 1072. Additionally, an accelerometer 1072 that is separate from the HMD 107 may be provided instead of providing the accelerometer 1072 in the HMD 107.

For example, the display device 1071 is a liquid crystal display, an electro-luminescent panel or the like. The display device 1071 may be formed by a processor dedicated to signal processing, and a program stored in a memory or the like. The display device 1071 may include a dedicated hardware circuit. In Example 1 and Examples 2 to 4 described later, the HMD 107 is included in the information processing apparatus 10, and provides the virtual space to a user by operating in conjunction with the CPU 101. However, processes in Example 1 and Examples 2 to 4 described later may alternatively be performed by another information processing apparatus on the network N. In this case, the HMD 107 provides the virtual space to a user by operating in conjunction with the other information processing apparatus. In the present example, the display device 1071 is provided at the HMD 107, but the display device 1071 may alternatively include glasses.

The display device 1071 includes a non-see-through display device that completely covers a visual range (a field of view) of a user wearing the HMD 107. The user thus observes only the image that is displayed on the display device 1071. That is, the user loses the field of view of outside world, and may immerse himself/herself in an image of the virtual space that is generated by the control circuit 1011 and displayed on the display device 1071.

The accelerometer 1072 is a sensor that measures a change in speed (acceleration) in a predetermined time range. The accelerometer 1072 detects the change in real time (every 1/80 seconds), and transmits detected information to the control circuit 1011 of the CPU 101 via the wireless I/F 104. The accelerometer 1072 is installed near the display device 1071 of the HMD 107, and is connected to the control circuit 1011 in a manner capable of communication. The accelerometer 1072 includes at least one of a geomagnetic sensor, an accelerometer, a tilt sensor, and an angular velocity (gyro) sensor, and is capable of detecting various movements of the HMD 107 worn on the head of the user. The accelerometer 1072 is not limited to be provided in the HMD 107, and a position tracking camera (a position sensor) or the like that is provided outside may be used instead, for example.

The accelerometer 1072 includes a function of detecting information about positions and inclinations of a plurality of detections points, not illustrated, provided on the HMD 107. However, the accelerometer 1072 may include a position tracking camera that captures the HMD 107. The position tracking camera detects positions, speeds, accelerations and the like of the plurality of detection points, not illustrated, provided on the HMD 107. The detection point is a light emitting unit that emits infrared rays or visible light, for example. The position tracking camera as the accelerometer 1072 includes an infrared sensor or a plurality of optical cameras. The control circuit 1011 may accurately associate a position of a virtual camera in the virtual space with a position, in a real space, of the user wearing the HMD 107, by acquiring position information of the HMD 107 from the accelerometer 1072.

Next, a method of acquiring information about the position and the inclination (an orientation of a visual axis) of the HMD 107 will be described. Information about the position and the inclination of the HMD 107 based on movement of the head of the user wearing the HMD 107 may be detected by the accelerometer 1072 installed in the HMD 107. A three-dimensional coordinate system (XYZ coordinates) is defined with the head of the user wearing the HMD 107 at a center. A perpendicular direction of a standing user will be given as a Y-axis, a direction that is orthogonal to the Y-axis and that connects a center of the display device 1071 and the user will be given as a Z axis, and a direction that is orthogonal to the Y-axis and the Z-axis will be given as an X-axis.

The accelerometer 1072 detects an angle around each axis (that is, an inclination determined by a yaw angle indicating rotation around the Y-axis, a pitch angle indicating rotation around the X-axis, and a roll angle indicating rotation around the Z-axis). The accelerometer 1072 determines, based on such change over time, angle (inclination) information data that is used by the control circuit 1011 to define (control) visual range information.

The controller A 108A and the controller B 108B are appliances that are operated while being held with left and right hands of the user or worn on the left and right hands of the user so that instructions are input by the user, and are an example of an information acquisition unit. In the present example, each of the controller A 108A and the controller B 108B includes a stick as means used by the user to input an instruction. For example, when the user tilts the stick of the controller A 108A or the controller B 108B to the left, the user views a scene that is viewed when an axis of his/her body, or in other words, a viewing direction is rotated in a left-hand direction in the virtual space. Furthermore, when the user tilts the stick to the right, the user views a scene that is viewed when the axis of the body, or in other words, the viewing direction is rotated in a right-hand direction in the virtual space. Input means for an instruction by the user is not limited to tilting of the stick of the controller with a finger, and instead, the controller may include a button and an instruction may be input by pressing of the button with a finger of the user.

In the present example, the user is assumed to perform operation by holding the controller A 108A and the controller B 108B with the left and right hands or by wearing the same on the hands, and thus, the information processing apparatus 10 includes two controllers. However, the number of controllers is not limited to two, and the user may input instructions in a state where one controller is held with both hands or is worn on both hands. Furthermore, the information processing apparatus 10 may include three or more controllers, and the user may input instructions by holding or wearing the controller(s) on part(s), of the user, other than the two hands (for example, on both feet). Moreover, the controller may include a touch panel display to allow the user to input instructions by touching a touch panel with a finger of the user. For example, instead of being a game console, the controller may be a portable device including a touch display, such as a smartphone, a personal digital assistant (PDA), a tablet computer, or a laptop personal computer (PC).

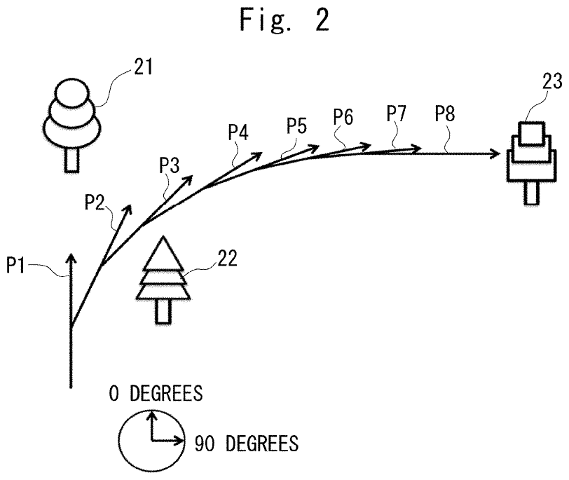

Next, a state of transition in an orientation and a line of sight of the user and a scene that is viewed by the user in the first example will be described with reference to FIGS. 2 to 4.

FIG. 2 is a transition diagram, according to Example 1, for a movement state of the user that is perceived by the user in the virtual space. The movement state here is illustrated using a position of the user and a direction (a scene) in the virtual space that is viewed by the user. Vectors P1 to P8 in FIG. 2 indicate, on a per-frame basis, direction vectors of movement in a predetermined time range, where the user turns to face a 90-degree direction (a right side as seen from the user, or in other words, a direction of an object 23) while the user is moving in a 0-degree direction (from a near side to a depth side as seen from the user, or in other words, a direction of an object 21).

In Example 1, in the case where the user turns to face the 90-degree (object 23) direction while moving in the 0-degree (object 21) direction, the user does not move from P1 to P8 at once. The scene in the virtual space that is viewed by the user changes in such a way that the user moves stepwise in the manner of P1, P2, P3, . . . , P8 in the predetermined time range. That is, scenes in P2 to P7 directions are generated by interpolating stages of change in movement while the scene in the virtual space that is viewed by the user changes from a scene in a P1 direction to a scene in a P8 direction, and are output to the HMD 107. With this interpolation process that is performed by the control circuit 1011 of the CPU 101 of the information processing apparatus 10, a change in the scene that is viewed by a person when the person changes the orientation to the 90-degree direction while moving in a straight direction (the 0-degree direction) in the virtual space is generated.

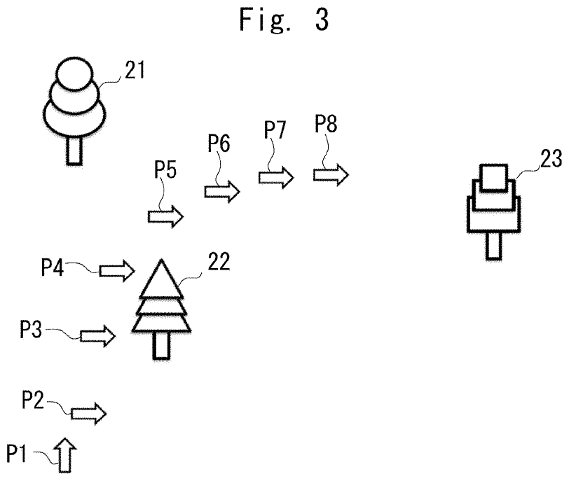

FIG. 3 is a transition diagram, according to Example 1, for a change in the position of the user in the virtual space perceived by the user and a change in a viewpoint direction of the user. Vectors P1 to P8 in FIG. 3 indicate, on a per-frame basis, the positions of the user and vectors of the viewpoint direction of the user in the virtual space in the predetermined time range, where the user turns to face the 90-degree direction (the right side as seen from the user, or in other words, the direction of the object 23) while the user is moving in the 0-degree direction (from the near side to the depth side as seen from the user, or in other words, the direction of the object 21). Additionally, the vectors P1 to P8 in FIG. 2 and the vectors P1 to P8 in FIG. 3 indicate same frames. That is, it is indicated by the vectors P1 to P8 that manners of lapse of time (time series) in FIG. 2 and FIG. 3 match each other.

Attention will be focused on the vectors of the viewpoint direction of the user from P1 to P8 in FIG. 3. The viewpoint direction of the user at P1 is the 0-degree direction (from the near side to the depth side as seen from the user, or in other words, the direction of the object 21), and the viewpoint direction of the user at P2 changes at once to face the 90-degree direction (the right side as seen from the user, or in other words, the direction of the object 23). Then, the viewpoint direction of the user is maintained at the 90-degree direction from P3 to P8. Accordingly, when comparing the vectors P1 to P8 of the movement direction of the user in FIG. 2 and the vectors P1 to P8 of the viewpoint direction of the user in FIG. 3, P1 and P8 match at the 0-degree direction and the 90-degree direction, respectively. However, with respect to P2 to P7, the viewpoint directions in FIG. 3 are all at 90 degrees while the movement directions in FIG. 2 are greater than 0 degrees and smaller than 90 degrees. That is, when grasping that the orientation of the user in the real space is rotated 90 degrees in the right-hand direction, the information processing apparatus 10 (CPU 101) immediately rotates the orientation of the user himself/herself in the virtual space from vector P2 to P8 in FIG. 3. At this time, the information processing apparatus 10 (CPU 101) changes the movement direction of the user in the virtual space from the direction at the vector P1 to the direction at the vector P8. In this case, the direction (that is, the scene) that is viewed by the user in the virtual space gradually changes stepwise in the manner of vectors P1 to P8 in FIG. 2. The change in the direction (that is, the change in angle) is relatively greatly changed at first, and a degree of change is gradually reduced.

Furthermore, in Example 1, the user is assumed to move in the viewing direction in the virtual space. As illustrated in FIGS. 2 and 3, in relation to a component of a movement amount of the user after 90-degree rotation is detected, a component of the vector P1 direction is great and a component of the vector P8 direction is small at first, for example, from the vector P1 to P2 and from P2 to P3. Then, the component of the vector P1 direction is gradually reduced, and the component of the vector P8 direction is gradually increased. Toward end of the change, the component of the vector P8 direction becomes dominant, and finally, there is only the component of the vector P8 in the virtual space, and the user is made to move in the P8 direction in the virtual space. The information processing apparatus 10 (the CPU 101) makes the user view the scene as described above in the virtual space.

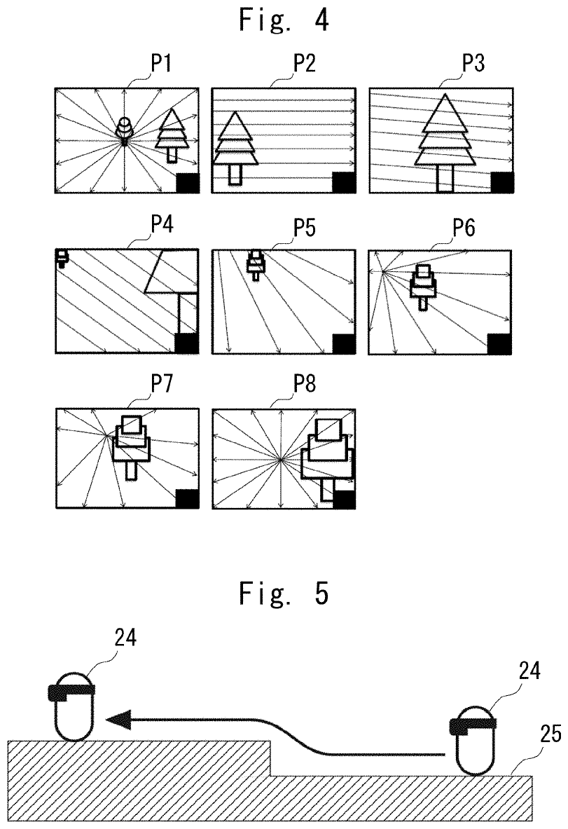

FIG. 4 is a transition diagram for images that are generated, in Example 1, by the control circuit 1011 based on information obtained from the accelerometer 1072 and that are output to (displayed on) the display device 1071 of the HMD 107. P1 to P8 each indicate an image that is output to the display device 1071 of the HMD 107, and arrows in each image indicate directions of a change in a range that is viewed by the user while the images change from P1 to P8. Additionally, manners of lapse of time (time series) indicated by P1 to P8 in FIG. 2, P1 to P8 in FIG. 3, and P1 to P8 in FIG. 4 match one another.

In P1, it is indicated that sizes of the object 21 that is displayed at a center of the image and an object 22 that is displayed on a right side in the image are gradually increased as the user moves in a direction of the object 21 displayed at the center of the image (the 0-degree direction). That is, radial arrows indicate a process of zoom-in where an angle of view of the virtual space that is being viewed by the user is gradually narrowed and the scene that is being viewed, or in other words, a viewing target is enlarged.

In P2, the orientation is changed to the 90-degree direction while the user is moving in the direction of the object 21 and the object 22. Accordingly, the object 21 that is viewed by the user at the center of the image in P1 is removed from the image, and the object 22 that is viewed at a center right in the image in P1 is moved to a center left in the image and is displayed with an increased size than in P1. At this time, the arrows indicate that the scene in the virtual space that is viewed by the user moves from left to right, and that the object 22 is gradually moved in a right direction.

In a state of the vector P3, the user moves approximately to front of the object 22 while maintaining the viewpoint direction at 90 degrees. Accordingly, the object 22 is displayed at approximately center of the image, with a size that is increased than in a state of the vector P2. Also, at this time, the arrows indicate that the scene in the virtual space that is viewed by the user moves from the left to the right, and that the object 22 is gradually moved in the right direction.

In a state of the vector P4, the user moves to near a left side of the object 22 and in a direction of the object 23 while maintaining the viewpoint direction at 90 degrees. Accordingly, the object 22 with an even increased size than in P3 is displayed at a right end in the image. Furthermore, the object 23 is displayed with a small size at a top left in the image. At this time, as indicated by the vector P4 in FIG. 2, the user gradually moves toward the object 23 in the virtual space. Accordingly, in the state of the vector P4 in FIG. 4, the arrows indicate that the scene in the virtual space that is viewed by the user moves from the top left toward a bottom right, and that the object 22 is gradually moved to back and the object 23 is gradually moved closer.

From the vector P5 to P7 in FIG. 4, the user moves somewhat to left of the object 23 while maintaining the viewpoint direction at 90 degrees. Accordingly, the object 23 is displayed from the top left toward the center in the image with the size being gradually increased. In a state of the vector P8 in FIG. 4, the user moves close to and somewhat to the left of the object 23 while maintaining the viewpoint direction at 90 degrees, and thus, the object 23 is displayed on a right side in the image with a size that is greater than in P7. At this time, the user moves in the vector P8 direction in FIG. 2 in the virtual space, and in the state of the vector P8 in FIG. 4, the arrows indicate that the scene that is viewed by the user in front is gradually enlarged.

A case is assumed where, in the case where the user changes the movement direction in the virtual space displayed on the display device 1071 of the HMD 107, to the direction at 90 degrees while moving in the straight direction (the 0-degree direction, or in other words, the P1 direction), the movement direction of the user is changed from P1 to P8 without interpolating P2 to P7. In this case, the image in FIG. 4 displayed on the display device 1071 of the HMD 107 changes at once from the state of the vector P1 in FIG. 4 to the state of P8. In this case, the user subconsciously expects the scene to gradually change in the manner of P2, . . . , P7 while the scene changes from P1 to P8. Furthermore, in real world, the user experiences a gradual change in the scene from P2 to P7 when changing a traveling direction as in FIGS. 2 and 3 while walking or moving on a vehicle such as a bicycle or a car. Accordingly, when the user perceives that the state of the vector P1 in FIG. 4 changes at once to the state of P8 in the virtual space, a difference is caused between mind or the experience of the user in the real world and the scene that is viewed by the user in the virtual space. This is thought to cause VR sickness in the user.

However, with the information processing apparatus 10 in Example 1, the control circuit 1011 interpolates, between P1 and P8, the scenes that change from P2 to P7 in a stepwise manner. Accordingly, a state where the movement direction and the mind of the user match may be maintained. Accordingly, VR sickness in the user may be prevented by using the information processing apparatus 10 in Example 1.

The “predetermined time range” mentioned above, or in other words, a time range in which P1 changes to P8 is set to 0.1 seconds to 0.3 seconds, for example. This range may be determined based on a speed of reaction of a person to an outside stimulus (such as visual stimulus or auditory stimulus). Accordingly, because the movement direction of the user using the information processing apparatus 10 according to Example 1, a line-of-sight direction, and the scene that is viewed are changed in a stepwise manner in conjunction with one another and according to a reaction speed of a person, VR sickness in the user may be prevented.

Furthermore, the “predetermined time range” mentioned above, or in other words, the time range in which P1 changes to P8 is set to substantially 0.2 seconds, for example. This is because, from empirical values, an average speed of reaction of a person to an outside stimulus (such as visual stimulus or auditory stimulus) is generally about 0.2 seconds. Accordingly, the movement direction of the user using the information processing apparatus 10 according to Example 1, the line-of-sight direction, and the scene that is viewed are changed in a stepwise manner in conjunction with one another and according to an average value of the reaction speed of a person. In this manner, by applying appropriate acceleration and delay by the interpolation process performed by the information processing apparatus 10, disorder of the autonomic nerves of the user may be prevented. More specifically, at the time of movement, direction change and the like of the user, the information processing apparatus 10 applies “delay time that is felt daily by the brain (about 0.2 seconds)” and “acceleration that is felt daily in the real world”. The information processing apparatus 10 thereby causes the brain of the user to perceive that delays and the like in the movement and a video of the VR space are “not different from daily life” and prevents disorder of the autonomic nerves, and VR sickness in the user may thus be further prevented. A delay time here may be said to be a response time of a person responding to an outside stimulus. Additionally, the delay time of about 0.2 seconds is only an example, and the delay time is not limited to about 0.2 seconds. The same can be said for each example described below.

When focusing on an angle of movement of the user in the virtual space in the predetermined time range, for example, P2 in FIG. 2 indicates the movement direction of the user when the user faces the 90-degree direction. P1 indicates the movement direction of the user one frame before the user turns to face the 90-degree direction. In FIG. 2, it is indicated that, between P1 (0 degrees) and P8 (90 degrees), a degree of change in a vector angle is gradually reduced from P2 to P7 that are intermediate time points between the two. This indicates that the control circuit 1011 generates the image based on a method of giving two vectors when a tip of a vector from an origin moves on a spherical surface including one radius, and interpolating and determining intermediate vectors (so-called spherical linear interpolation). A vector direction (angle) in the case of performing spherical linear interpolation is calculated by multiplying, by an attenuation rate (a constant rate), an angle difference between “a direction in which the user is currently moving (the movement direction)” (the vectors P1, P2, . . . , P7) and “a direction the user is facing (the viewpoint direction)” (the vector P8). In the case where the attenuation rate is constant, an angle of interpolation is gradually reduced as interpolation progresses in the manner of P1, P2, and so on.

Furthermore, in relation to the movement direction of the user in FIG. 2 in Example 1, a change in the angle of the vector from P1 to P2 and a change in the angle of the vector from P7 to P8 are compared with each other. In the case where the movement direction of the user in FIG. 2 changes from P1 (0 degrees) to P2 (substantially 35 degrees), the angle is changed by substantially 35 degrees. In contrast, in the case where the movement direction of the user in FIG. 2 changes from P7 (substantially 85 degrees) to P8 (90 degrees), the angle is changed by substantially 5 degrees. Accordingly, the angle of change in the movement direction of the user in FIG. 2 from P7 to P8 can be said to be more gradual than the angle of change from P1 to P2. In the same manner, it can be seen that the angles of changes from P2 to P3, P3 to P4, . . . , P6 to P7 are gradually reduced to be more gradual.

Here, with respect to the change from P1 to P8 in the predetermined time period, a change from P1 to P5 will be specified as a start period part, and a change from P5 to P8 will be specified as an end period part. In this case, the control circuit 1011 can be said to generate images that are viewed in the virtual space in such a way that a change per time in the scene in the end period part is a more gradual change than a change per time in the scene in the start period part, and to output the images to the display device 1071 of the HMD 107 in a stepwise manner. The user may thus feel that the change in the scene that is viewed in the virtual space that is displayed by the HMD 107 is the same as a change in a real scene that is viewed by a person. Accordingly, the user is not likely to feel uncomfortable about a change in the image displayed by the display device 1071 and may perceive a natural change, and the user may be prevented from feeling VR sickness.

Furthermore, in Example 1, as the time series progresses in the manner of P1 to P2, P2 to P3, . . . , P7 to P8, the angle of change in the vector direction based on the spherical linear interpolation becomes smaller and more gradual. Accordingly, the user is even more unlikely to feel uncomfortable about a change in the image displayed by the display device 1071 and may perceive a natural change, and the user may be further prevented from feeling VR sickness.

Additionally, in FIGS. 2 to 4, an example process is described where, in the case where the user changes the orientation 90 degrees in the right-hand direction while moving straight in the virtual space, the information processing apparatus 10 makes the user view a gradually changing scene in the virtual space using interpolated images. However, the process by the information processing apparatus 10 is not limited to the case where the user changes the orientation 90 degrees in the right-hand direction while moving straight. That is, the CPU 101 acquires, from the accelerometer 1072, the controller A 108A, or the controller B 108B, information that causes at least one of movement of the position of the user and a change in the orientation of the user in the virtual space. This information includes information that causes only the acceleration to change rapidly without changing the straight direction, for example. Furthermore, the information includes a case where the orientation is changed left and right by various angles without being limited to 90 degrees in the right-hand direction. Furthermore, the information includes a case where only the orientation is changed left and right by various angles with no movement in the straight direction, for example. Moreover, the information includes a case where the orientation or the movement direction of the user is changed in a height direction without being limited to a change on a horizontal plane.

FIG. 5 is a diagram illustrating an example where a user 24 changes the movement direction in a height direction in the virtual space. In FIG. 5, the user 24 in the virtual space moves on a ground 25 from the right-hand direction to the left-hand direction, for example. An arrow illustrated in FIG. 5 indicates a track of movement of the user 24 in the virtual space. There is a step on the ground, near a center in a left-right direction. The track of movement of the user 24 moving over the step (changing the movement direction in the height direction) in the virtual space is interpolated by the process of spherical linear interpolation performed by the information processing apparatus 10. Accordingly, the track is interpolated such that movement over the step is not linear but a gentle curve. In the real world, when the user moves over a step while walking, the user may experience movement over the step by a track that is interpolated not into a straight line but into a smooth curve as illustrated in FIG. 5. Accordingly, the movement direction and the mind of the user may be maintained in a matched state. Accordingly, by using the information processing apparatus 10 in Example 1, VR sickness in the user may be prevented also in a case where the user changes the movement direction in the height direction.

FIG. 5 illustrates the process performed by the information processing apparatus 10 at a time when the user 24 in the virtual space moves on the ground 25 from the right-hand direction to the left-hand direction. However, the process by the information processing apparatus 10 is not limited to such a process. The information processing apparatus 10 may perform the same process as the interpolation in FIG. 5 also for a track of movement of the user 24 in the virtual space when the user 24 moves on the ground 25 from the left-hand direction to the right-hand direction.

The CPU 101 acquires a signal about such a change from the real world, from the accelerometer 1072, the controller A 108A, or the controller B 108B. Then, based on the acquired signal, the user is made to view, in the virtual space, the change in the scenes that are interpolated in the manner described above. Additionally, spherical linear interpolation is an example of the interpolation method, and interpolation by the information processing apparatus 10 is not limited to spherical linear interpolation. The information processing apparatus 10 detects information (signal from the accelerometer 1072, the controller A 108A, or the controller B 108B) for causing the orientation of the user to change or the position to be moved in the virtual space, for example. In this case, the information processing apparatus 10 may change the orientation or the position of the user in the virtual space in such a way that acceleration or angular acceleration is gradually reduced toward the orientation in an end state of change in the orientation of the user or an end point of movement of the position. Furthermore, the information processing apparatus 10 may perform a process that is approximate to spherical linear interpolation, by performing a process of continuous “linear interpolation (a method of linearly approximating function values between two points)” in the predetermined time range. The process of continuous “linear interpolation (a method of linearly approximating function values between two points)” is to repeatedly perform a process of linear interpolation in a stepwise manner until the change in the orientation or the position of the user reaches the end state from a start state. The same applies to each example described below. The interpolation process by continuous linear interpolation by the information processing apparatus 10 can be said to be a process with relatively less load than the interpolation process by spherical linear interpolation. Accordingly, when the information processing apparatus 10 performs the interpolation process by the continuous linear interpolation, not only VR sickness in the user may be prevented, but also load of the process may be reduced than in the case of performing the interpolation process by spherical linear interpolation.

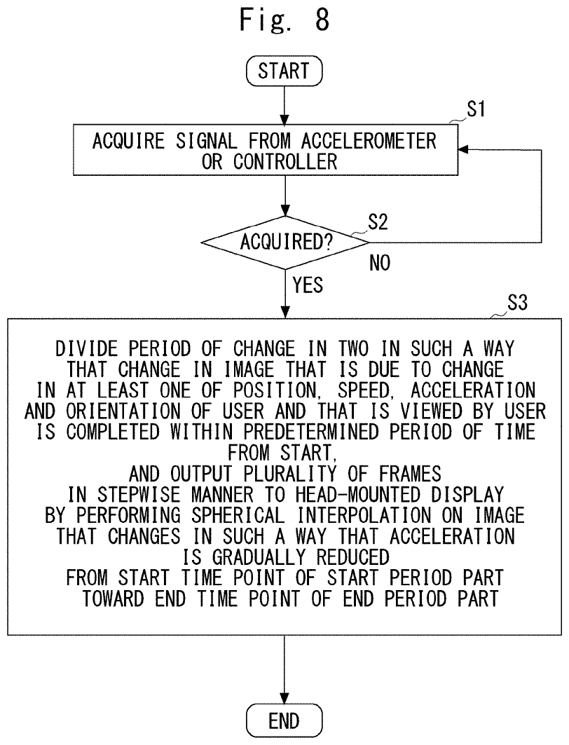

FIG. 8 is a flowchart illustrating an example of a process, according to Example 1. First, in the process in Example 1, the CPU 101 acquires a detection signal from the accelerometer 1072 or an operation signal from the controller A 108A or the controller B 108B (step S1). The detection signal from the accelerometer 1072 indicates a change in a posture of the user, a change in the orientation, a motion of the user, and the like. The CPU 101 generates an image illustrating a change in the scene in the virtual space caused by movement of the user, based on the detection signal from the accelerometer 1072. Furthermore, the operation signal from the controller A 108A or the controller B 108B is an instruction regarding a movement speed, acceleration, the movement direction and the like of the user in the virtual space, for example. The CPU 101 generates an image illustrating a change in the scene in the virtual space caused by movement of the user, based on the operation signal.

Accordingly, in this process, the CPU 101 determines whether the detection signal from the accelerometer 1072 or the operation signal from the controller A 108A or the controller B 108B is acquired or not (step S2). The detection signal or the operation signal can be said to be an example of information that causes at least one of movement of the position of the user and a change in the orientation of the user in the virtual space. Alternatively, the CPU 101 may be said to perform the process in step S1, as an example of an information acquisition unit that acquires information that causes at least one of movement of the position of the user and a change in the orientation of the user in the virtual space.

In the case where the detection signal from the accelerometer 1072 or the operation signal from the controller A 108A or the controller B 108B is acquired by the control circuit 1011 (Yes in step S2), step S3 is performed. The control circuit 1011 of the CPU 101 generates an image in the virtual space based on the detection signal or the operation signal that is acquired. In the case where neither the detection signal nor the operation signal is acquired by the control circuit 1011 (No in step S2), the process returns to step S1.

In step S3, the control circuit 1011 generates an image where the scene that is viewed by the user in the virtual space changes in the predetermined time range. More specifically, the control circuit 1011 generates the image by dividing the same into a plurality of frames, in such a way that a change in the image that is viewed by the user, caused by a change in at least one of the position, the speed, the acceleration, and the orientation of the user in the virtual space is completed within a predetermined period of time from start. Furthermore, the control circuit 1011 specifies a start period part and an end period part in a period of change in the predetermined time range. In this case, the control circuit 1011 generates the image that is viewed in the virtual space, in such a way that a change per time in the scene in the end period part is a more gradual change than a change per time in the scene in the start period part. The control circuit 1011 outputs the generated image to the HMD 107 through the wireless I/F 104 in a stepwise manner. By this process, the control circuit 1011 makes the user view a scene in the virtual space that is changed in a stepwise manner in the predetermined time range. That is, the control circuit 1011 outputs a corresponding frame to the HMD 107 in a predetermined frame period in such a way that the scenes as indicated by the vectors P1 to P8 in FIG. 4 are formed in the virtual space. The control circuit 1011 performs the process in step S3, as an example of a control unit that outputs, to the display device, an image in which the scene that is viewed by the user in the virtual space is changed in the predetermined time range.

As examples of a change in movement speed/movement direction, the following can be cited. Here, it is assumed that the user “moves” by a controller in the left hand, and that a stick of the controller A 108A (or the controller B 108B) is always operated with the left hand. In a first case, the user tilts the stick of the controller in a +45-degree direction while the user in the virtual space is facing the 0-degree direction. In this case, the user in the virtual space moves obliquely in a 45-degree direction while facing the 0-degree direction and while smoothly accelerating from a stopped state. When the user removes the finger from the stick of the controller A 108A or the like and the stick of the controller A 108A or the like is returned to an original position, the user in the virtual space smoothly decelerates and stops. To smoothly accelerate means that the acceleration is gradually increased as described above. Furthermore, to smoothly decelerate means that the acceleration is gradually reduced. The same applies to below.

In a second case, the user tilts the stick of the controller A 108A or the like in a +180-degree direction while the user in the virtual space is facing the 0-degree direction. In this case, the user in the virtual space moves backward (moves in a 180-degree direction) while facing the 0-degree direction and while smoothly accelerating from the stopped state. When the user removes the finger from the stick of the controller A 108A or the like and the stick of the controller A 108A or the like is returned to the original position, the user in the virtual space smoothly decelerates and stops.

In a third case, the user tilts the stick of the controller A 108A or the like in a +30-degree direction while the user in the virtual space is facing the 90-degree direction. In this case, the user in the virtual space moves obliquely in a 120-degree direction while facing the 90-degree direction and while smoothly accelerating from the stopped state. When the user removes the finger from the stick of the controller A 108A or the like and the stick of the controller A 108A or the like is returned to the original position, the user in the virtual space smoothly decelerates and stops.

In a fourth case, the user tilts the stick of the controller A 108A or the like in a −30-degree direction while the user in the virtual space is facing the 90-degree direction. In this case, the user in the virtual space moves obliquely in a 60-degree direction while facing the 90-degree direction and while smoothly accelerating from the stopped state. When the user removes the finger from the stick of the controller A 108A or the like and the stick of the controller A 108A or the like is returned to the original position, the user in the virtual space smoothly decelerates and stops.

In a fifth case, the user tilts the stick of the controller A 108A or the like in the 0-degree direction while the user in the virtual space is facing the 90-degree direction. In this case, the user in the virtual space moves straight in a facing direction while facing the 90-degree direction and while smoothly accelerating. When the user removes the finger from the stick of the controller A 108A or the like and the stick of the controller A 108A or the like is returned to the original position, the user in the virtual space smoothly decelerates and stops.

In a sixth case, the user tilts the stick of the controller A 108A or the like in the 0-degree direction while the user in the virtual space is facing a −139-degree direction. In this case, the user in the virtual space moves straight in the facing direction while facing the −139-degree direction and while smoothly accelerating. When the user removes the finger from the stick of the controller A 108A or the like and the stick of the controller A 108A or the like is returned to the original position, the user in the virtual space smoothly decelerates and stops.

As a seventh case, there is cited an example where the user changes a viewpoint toward a 30-degree direction while the user in the virtual space in the first case is moving obliquely in a 45-degree direction. The user turns to face the 30-degree direction in a state where the user in the virtual space is moving obliquely in the 45-degree direction, with the stick of the controller A 108A or the like being tilted by the user in a +45-degree direction, while the user in the virtual space is facing the 0-degree direction. In this case, the movement direction smoothly changes from 45 degrees to 75 degrees while the user in the virtual space is facing the 30-degree direction, and the user moves obliquely in a 75-degree direction while facing the 30-degree direction. Here, that the movement direction smoothly changes from one angle to another angle means that a temporal change of the change in the orientation, or in other words, the angular acceleration is gradually reduced in the virtual space as in FIG. 2.

According to Example 1, the information processing apparatus 10 enables the user to view a scene that changes in a stepwise manner in the virtual space, based on the detection signal from the accelerometer 1072 or the operation signal from the controller A 108A or the controller B 108B. Accordingly, the scene that is viewed by the user is close to the one that is expected by the user or that is experienced by the user in the real world. VR sickness in the user in the virtual space may thus be prevented.

Furthermore, in Example 1, the predetermined time range required for the state of the vector P1 to change to the state of P8 is 0.1 seconds to 0.3 seconds. This time range is a time that is suitable, empirically or from ergonomics point of view, to prevent VR sickness in the user. Furthermore, in Example 1, the predetermined time range is set to substantially 0.2 seconds. This time is a time that is even more suitable, empirically or from ergonomics point of view, to prevent VR sickness in the user. In this manner, because appropriate acceleration and delay may be applied to the movement of the user in the virtual space by the interpolation process by the information processing apparatus 10, disorder of the autonomic nerves of the user may be prevented. More specifically, at the time of movement, direction change and the like of the user, the information processing apparatus 10 applies “delay time that is felt daily by the brain (about 0.2 seconds)” and “acceleration that is felt daily in the real world”. The information processing apparatus 10 thereby causes the brain of the user to perceive that delays and the like in the movement and a video of VR space are “not different from daily life” and prevents disorder of the autonomic nerves, and VR sickness in the user may thus be further prevented.

With respect to the angle of the movement direction of the user, the angle of change from P7 to P8 is more gradual than the angle of change from P1 to P2. This can be said to be an example of the change per time in the scene in the end period part being a more gradual change than the change per time in the scene in the start period part.

Accordingly, the user is not likely to feel uncomfortable about a change in the scene displayed by the display device 1071 and may perceive a natural change. Therefore, VR sickness in the user in the virtual space may be prevented.

Furthermore, in Example 1, spherical linear interpolation is performed on the image (scene) in the virtual space that is generated by the control circuit 1011 and output to the display device 1071. As the time series progresses in the manner of P1 (a start time point of the start period part) to P2, P2 to P3, . . . , P7 to P8 (an end time point of the end period part), a change in the angle of the vector direction based on the spherical linear interpolation gradually becomes smaller.

This can be said to be an example of the change per time in the scene being a change that causes a change in an angle of a direction that is viewed by the user in the virtual space to be gradually reduced from the start time point of the start period part toward the end time point of the end period part. Accordingly, the user is even more unlikely to feel uncomfortable about a change in the image displayed by the display device 1071 and may perceive a natural change. The user may thus be further prevented from feeling VR sickness in the virtual space.

FIGS. 2 to 4 and FIG. 8 illustrate a process for a case where the user turns to face the 90-degree (object 23) direction while moving in the 0-degree (object 21) direction. A process for a case where the user, without changing the orientation, changes the movement speed in the straight direction (front-back direction) or moves from the stopped state and then stops is as described below. For example, the CPU 101 acquires the operation signal from the controller A 108A or the controller B 108B, and determines the same to be an instruction from the user regarding movement start, movement stop, movement speed, acceleration or the like. For example, the user starts forward movement (movement in the straight direction) in the virtual space and changes the movement speed, the acceleration or the like by tilting the stick of the controller A 108A or the controller B 108B forward. Furthermore, for example, the user instructs forward movement (movement in the straight direction) in the virtual space to stop, by tilting back the stick of the controller A 108A or the controller B 108B that is tilted forward.

Then, the CPU 101 gradually increases acceleration of the user in the virtual space until a peak speed is temporarily reached, and then gradually reduces the acceleration toward stop. More specifically, the scene that is viewed by the user in the virtual space that is displayed by the display device 1071 of the HMD 107 is gradually accelerated to swiftly change and to temporarily change at the peak speed. Then, the scene that is viewed by the user changes in such a way that the acceleration is gradually reduced toward stop to finally stop changing. The peak speed here is a fastest speed between start of the forward movement (movement in the straight direction) of the user in the virtual space and stopping.

For example, when the stick is tilted forward by the user, acceleration is smoothly performed in the facing direction from the stopped state over about 0.2 seconds. Then, when the stick is returned to neutral due to removal of the finger, the CPU 101 changes the frame of the image that is viewed by the user in the virtual space in such a way that deceleration is performed smoothly over about 0.2 seconds before stopping. Thanks to such a process, the user is even more unlikely to feel uncomfortable about a change in the image displayed by the display device 1071 and may perceive a natural change. In this manner, because appropriate acceleration and delay may be applied to the movement of the user in the virtual space by the interpolation process by the information processing apparatus 10, disorder of the autonomic nerves of the user may be prevented. More specifically, at the time of movement, direction change and the like of the user, the information processing apparatus 10 applies “delay time that is felt daily by the brain (about 0.2 seconds)” and “acceleration that is felt daily in the real world”. The information processing apparatus 10 thereby causes the brain of the user to perceive that delays and the like in the movement and a video of VR space are “not different from daily life” and prevents disorder of the autonomic nerves, and VR sickness in the user may thus be further prevented.

### SECOND EXAMPLE

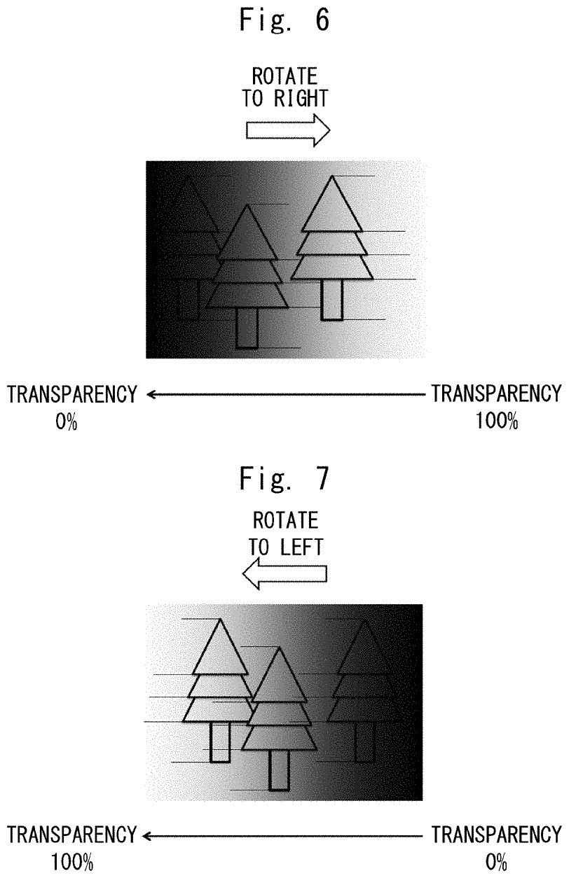

A second example (also referred to as “Example 2”) will be described with reference to FIGS. 6, 7, and 9. The configuration of the information processing apparatus is the same between the first example and the second example, and thus, description of FIG. 1 is omitted in the second example. FIG. 6 is related to acquisition of information by the information acquisition unit, the information being for causing, in the virtual space in Example 2, at least one of movement of the position of the user and a change in the orientation of the user. An image that is generated by the control circuit 1011 based on the information that is acquired in a case where the user turns right is illustrated.

In the present diagram, a movement destination (rotation direction) of the user in the virtual space, or in other words, a right end of the image is brightly displayed (transparency: 100%), and the image is gradually darkened from the right end toward a left side of the image, and a left end of the image that is a movement origin is displayed at a transparency of 0%. This is because gradation is applied by the control circuit 1011 in such a way that the image is displayed while being gradually darkened in an opposite direction from the rotation direction of the user so as to guide the viewpoint of the user to the movement destination (the rotation direction). The transparency here refers to transparency of an image of a shadow for generating gradation. The transparency of 100% is a case where there is no image of a shadow. The transparency of 0% is a case where the image of a shadow is darkest, and is a state where the user is not able to view an original image before application of gradation.

FIG. 7 is opposite FIG. 6, and illustrates an image for a case where the user turns left in the virtual space in Example 2. In the present diagram, the movement destination (rotation direction) of the user in the virtual space, or in other words, the left end of the image is brightly displayed (transparency: 100%), and the image is gradually darkened from the left end toward a right side of the image, and the right end of the image that is the movement origin is displayed at the transparency of 0%. This is because, as in the case in FIG. 6, gradation is applied by the control circuit 1011 in such a way that the image is displayed while being gradually darkened in an opposite direction from the rotation direction of the user so as to guide the viewpoint of the user to the movement destination (the rotation direction).

In FIGS. 6 and 7, with respect to a degree of change in the transparency (gradation) from one end to the other end of the image, the image that is generated by the control circuit 1011 is processed such that transparency at an intermediate portion between the movement destination (transparency: 100%) of the user and the movement origin (transparency: 0%) is substantially 50%. However, such a case is not restrictive, and it suffices when the image is formed in such a way that the movement destination is brighter relative to the movement origin in the movement direction of the line of sight of the user in the virtual space. For example, the degree of gradation (transparency) may be adjusted as appropriate according to specifics of the image that is generated by the control circuit 1011, by making the transparency at the movement destination smaller than 100%, making the transparency at the movement origin greater than 0%, or processing the transparency at the intermediate portion to be 30% or 70%.

A change in the transparency of the image in the case where the user turns in a right or left direction is described with reference to FIGS. 6 and 7. Example 2 is not limited to such a case, and the control circuit 1011 may generate an image that is adjusted in such a way that the transparency at the movement destination of the user is increased and the transparency at the movement origin is reduced according to rotation of the user in the front-back direction or an oblique direction.

When the control circuit 1011 generates an image as illustrated in FIG. 6 or 7 and outputs (displays) the same on the display device 1071 of the HMD 107, the viewpoint of the user looking at the image is guided from the movement origin (a dark direction with low transparency) to the movement destination (a bright direction with high transparency). Accordingly, the user is able to predict the movement destination in the virtual space, and VR sickness in the user in the virtual space may be prevented.

The images illustrated in FIGS. 6 and 7 where the transparency of the image of the shadow is changed from one end to the other end of the images are generated in the case where information that causes at least one of movement of the position of the user and a change in the orientation of the user in the virtual space is acquired by the control circuit 1011. Then, the image that is generated is output to (displayed on) the display device 1071 of the HMD 107. With respect to such a change, the control circuit 1011 may acquire the information that causes at least one of movement of the position of the user and a change in the orientation of the user, through operation of an operation unit of the information acquisition unit such as the controller A 108A or the controller B 108B by the user.

For example, in the case where a finger of the right hand or the left hand of the user tilts the stick of the controller A 108A or the controller B 108B to the right, input information is transmitted to the control circuit 1011, and the control circuit 1011 generates an image as illustrated in FIG. 6 and outputs (displays) the image to the display device 1071. When the stick of the controller is tilted to the left, input information is transmitted to the control circuit 1011, and the control circuit 1011 generates an image as illustrated in FIG. 7 and outputs (displays) the image to the display device 1071. When the user himself/herself operates the information acquisition unit, an image, the transparency of which changes from one end to the other end, as illustrated in FIG. 6 or 7 is displayed by the display device 1071. Accordingly, consistency between an input operation of the user and the image that is viewed by the user is increased, and VR sickness in the user in the virtual space may be prevented.

With the images as illustrated in FIGS. 6 and 7, that the display device 1071 of the HMD 107 moved following movement of an object displayed in the virtual space is detected by the information acquisition unit such as the accelerometer 1072. The information acquisition unit may acquire information that causes at least one of movement of the position of the user and a change in the orientation of the user. For example, the user wearing the HMD 107 may turn right following movement, in the right direction, of an object displayed in the image of the virtual space. In this case, the accelerometer 1072 detects the movement, information that is acquired is transmitted to the control circuit 1011, and the control circuit 1011 generates an image as illustrated in FIG. 6 and outputs (displays) the image to the display device 1071. Alternatively, the user wearing the HMD 107 may turn left following movement, in the left direction, of an object displayed in the image of the virtual space. In this case, the accelerometer 1072 detects the movement, information that is acquired is transmitted to the control circuit 1011, and the control circuit 1011 generates an image as illustrated in FIG. 7 and outputs (displays) the image to the display device 1071.

When the information acquisition unit detects movement of the user (the display device 1071) matching movement of an object displayed in the virtual space, an image, the transparency of which changes from one end to the other end, as illustrated in FIG. 6 or 7 is displayed by the display device 1071. Accordingly, consistency between movement of the user and the image that is viewed by the user is increased, and VR sickness in the user in the virtual space may be prevented.

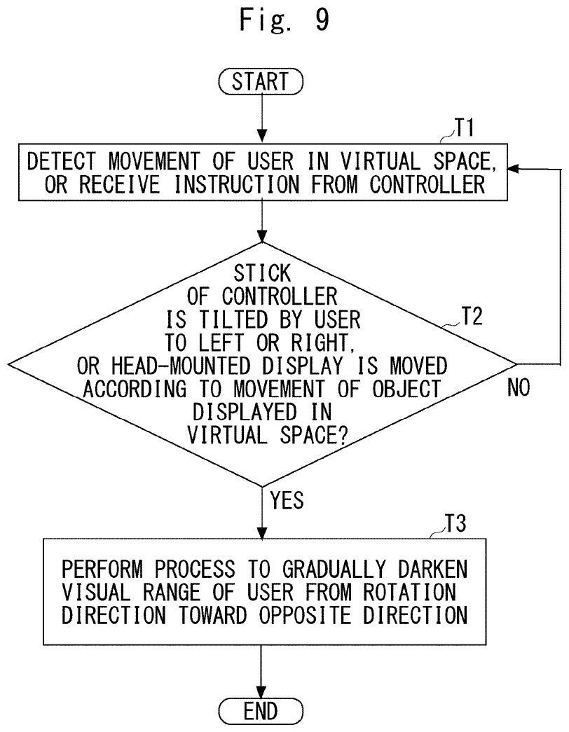

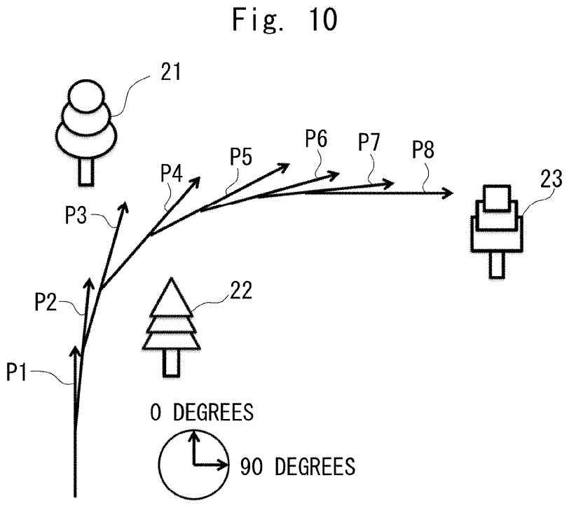

FIG. 9 is a flowchart illustrating an example of a process, according to Example 2.

The accelerometer 1072 of the HMD 107 detects movement of the user in the virtual space displayed by the display device 1071. Alternatively, the accelerometer 1072 receives an instruction from the user based on operation of the controller by the user (step T1).

The controller A 108A or the controller B 108B determines whether the stick of the controller A 108A or the controller B 108B is tilted to the left or right by the user. Alternatively, the accelerometer 1072 determines whether the head-mounted display is moved according to movements of the objects 21 to 23 displayed in the virtual space (step T2).

The controller A 108A or the controller B 108B may determine that the stick of the controller A 108A or the controller B 108B is tilted to the left or right by the user. Alternatively, in the case where the accelerometer 1072 determines that the head-mounted display is moved according to movements of the objects 21 to 23 displayed in the virtual space (Yes in step T2), the process proceeds to step T3. In these cases, the information on results of the above-determination is transmitted to the control circuit 1011 of the CPU 101 via the wireless I/F 104. In other cases (No in step T2), the process returns to step T1.

The control circuit 1011 generates, based on the information on the results of the above-determination, an image that is processed in such a way that the visual range of the user is gradually darkened from the rotation direction toward the opposite direction (step T3).

The generated image is output from the control circuit 1011 to the HMD 107 via the wireless I/F 104. The HMD 107 receives the image, and displays the image in the virtual space of the display device 1071 in a manner that can be viewed by the user.

With the process in Example 2, the CPU 101 determines whether the detection signal from the accelerometer 1072 or the operation signal from the controller A 108A or the controller B 108B is acquired or not (step T2). The detection signal or the operation signal can be said to be an example of information that causes at least one of movement of the position of the user and a change in the orientation of the user in the virtual space. The CPU 101 can be said to perform the process in step T1, as an example of the information acquirer that acquires information that causes at least one of movement of the position of the user and a change in the orientation of the user in the virtual space.

Furthermore, the CPU 101 generates, based on the detection signal or the operation signal that is acquired, an image that is processed in such a way that the visual range of the user is gradually darkened from the rotation direction (the movement destination) toward the opposite direction (the movement origin) (step T3). The CPU 101 outputs the image to the HMD 107. The HMD 107 receives the image, and displays the image in the virtual space of the display device 1071. Accordingly, the CPU 101 can be said to perform the process in step T3, as an example of a control circuit that forms an image, based on information that is acquired, in such a way that the movement destination is brighter relative to the movement origin in the movement direction of the line of sight of the user in the virtual space, and that outputs the image to the display device in a manner that can be viewed by the user.

Moreover, the viewpoint of the user viewing the image is guided from the movement origin (low transparency, dark) to the movement destination (high transparency, bright). Accordingly, the user may predict the movement destination in the virtual space. VR sickness in the user in the virtual space may thus be prevented.

In Example 2, when the user tilts the stick of the controller A 108A or the controller B 108B to the left or right, the control circuit 1011 acquires information that causes at least one of movement of the position of the user and a change in the orientation of the user (step T1). This can be said to be an example of acquisition, by the information acquirer, of information that causes at least one of movement of the position of the user and a change in the orientation of the user, based on operation of the operation unit of the information acquisition unit by the user.

In this manner, an image, the transparency of which changes from one end to the other end, is displayed by the display device 1071 based on operation of the information acquisition unit by the user himself/herself. Accordingly, consistency between an input operation of the user and the image that is viewed by the user is increased, and VR sickness in the user in the virtual space may be prevented.

Furthermore, in Example 2, in the case where the display device 1071 of the HMD 107 worn by the user moves according to movement of an object displayed in the virtual space, the accelerometer 1072 detects the movement, and the control circuit 1011 acquires the information that is detected (step T1). This can be said to be an example of acquisition, by the information acquirer, of information that causes at least one of movement of the position of the user and a change in the orientation of the user, based on detection, by a detector of the information acquirer, of movement of the display device according to movement of an object displayed in the virtual space.

In this manner, when the information acquisition unit detects a movement of the user according to movement of an object displayed in the virtual space, an image, the transparency of which changes from one end to the other end, is displayed by the display device 1071. Accordingly, consistency between movement of the user and the image that is viewed by the user is increased, and VR sickness in the user in the virtual space may be prevented.

### THIRD EXAMPLE

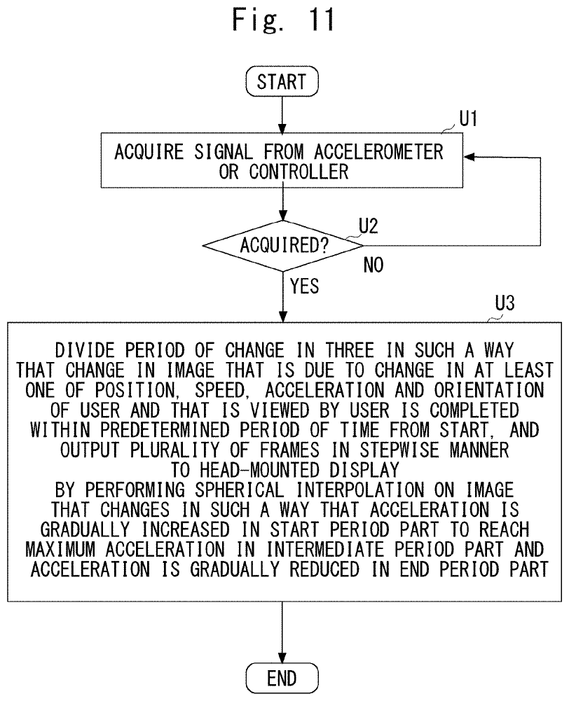

A third example (also referred to as “Example 3”) will be described with reference to FIGS. 10 and 11. In Example 1, a process for a case where the user turns to face the 90-degree (object 23) direction while moving in the 0-degree (object 21) direction is described. In Example 1, a process is illustrated, according to which the orientation of the user himself/herself in the virtual space is immediately rotated as indicated by the vectors P2 to P8 in FIG. 8 when 90-degree rotation, in the real space, of the orientation of the user in the right-hand direction is grasped (see FIGS. 2 to 4). In Example 3, when 90-degree rotation, in the real space, of the orientation of the user in the right-hand direction is grasped, rotation of the orientation of the user himself/herself in the virtual space is gradually accelerated. In the illustrated process, the orientation of the user then temporarily rotates at a peak angular velocity, and angular acceleration of the rotation is then gradually reduced such that a final orientation of the user is reached. The peak angular velocity here is a greatest angular velocity between after the user changes the orientation and until movement of the user in the virtual space becomes straight movement at the final orientation of the user. Other configurations and processes are the same as those in Example 1, and Example 1 is assumed to be applied to Example 3 with respect to same processes, and differences will be described below.

FIG. 10 is a transition diagram for a movement state of the user that is perceived by the user in the virtual space, according to Example 3. The movement state here is indicated by the position of the user and a direction (a scene) that is viewed by the user in the virtual space. Vectors P1 to P8 in FIG. 10 indicate, on a per-frame basis, speed of movement and direction vectors of movement in the predetermined time range, where the user turns to face the 90-degree direction (the right side as seen from the user, or in other words, the direction of the object 23) while the user is moving in the 0-degree direction (from the near side to the depth side as seen from the user, or in other words, the direction of the object 21). When focusing on the vectors of the viewpoint direction of the user from P1 to P8, the direction (that is, the scene) in the virtual space that is viewed by the user gradually changes in a stepwise manner as indicated by the vectors P1 to P8 in FIG. 10. The angle of the vector is gradually increased from P1 to P3 and is gradually reduced from P6 to P8, with a change in the angle being greatest at P4 and P5. With respect to a period from P1 to P8, a period from P1 to P3 may be said to be a start period part, a period from P6 to P8 may be said to be an end period part, and a period of P4 and P5 may be said to be an intermediate period part sandwiched between the start period part and the end period part. Accordingly, with respect to a temporal change (angular acceleration) of a temporal change in speed (that is, acceleration) and a temporal change in direction (angular velocity), a degree of change (acceleration, angular acceleration) is gradually increased at first (that is, in the start period part), and a maximum change amount is temporarily reached in the intermediate period part. Then (that is, in the end period part), the degree of change (acceleration, angular acceleration) is gradually reduced. That is, the number of parts into which the period is divided and the degree of change are different from those in Example 1 where the change is relatively great at first (that is, in the start period part), and then (that is, in the end period part), the degree of change is gradually reduced.

FIG. 11 is a flowchart illustrating an example of a process, according to Example 3. Differences from the flowchart in Example 1 are as follows. In Example 1, in the process in step S3 of the flowchart in FIG. 8, the CPU 101 divides a period of change into two in such a way that a change in the image that is seen by the eyes of the user, caused by a change in at least one of the position, the speed, the acceleration, and the orientation of the user, is completed within a predetermined period of time from the start. Then, the image that is changed in such a way that the acceleration is gradually reduced from the start time point of the start period part to the end time point of the end period part is divided into a plurality of frames by spherical interpolation, and output to the HMD 107 in a stepwise manner. In Example 3, in the process in step U3 of the flowchart in FIG. 11, the period of change of the image that is generated by the CPU 101 is divided into three. The difference from the process in Example 1 is that the image is changed in such a way that the acceleration is gradually increased in the start period to reach the peak acceleration in the intermediate period, and that the acceleration is gradually reduced in the end period.

Accordingly, with the information processing apparatus 10 in Example 3, the control circuit 1011 divides a period between P1 and P8 into the start period part, the intermediate period part, and the end period part. Furthermore, the control circuit 1011 interpolates scenes that change stepwise between P2 and P7 in such a way that a change per time in the scene in the start period part and the end period part is more gradual than a change per time in the scene in the intermediate period part. Accordingly, also in Example 3, as in Example 1, the user is not likely to feel uncomfortable about a change in the image displayed by the display device 1071 and may perceive a natural change. Therefore, VR sickness in the user in the virtual space may be prevented.

The “predetermined time range” mentioned above, or in other words, a time range in which P1 changes to P8 is set to 0.1 seconds to 0.3 seconds, for example. This range may be determined based on a speed of reaction of a person to an outside stimulus (such as visual stimulus or auditory stimulus). Accordingly, because the movement direction of the user using the information processing apparatus 10 according to Example 3, the line-of-sight direction, and the scene that is viewed are changed in a stepwise manner in conjunction with one another and according to a reaction speed of a person, VR sickness in the user may be further prevented.

The process related to forward movement (movement in the straight direction) of the user in the virtual space, described in Example 1, is the same in Example 3 as in Example 1. That is, for example, the user starts forward movement (movement in the straight direction) in the virtual space and changes the movement speed, the acceleration or the like by tilting the stick of the controller A 108A or the controller B 108B forward. Furthermore, for example, the user instructs forward movement (movement in the straight direction) in the virtual space to stop, by tilting back the stick of the controller A 108A or the controller B 108B that is tilted forward.

Then, the CPU 101 gradually increases acceleration of the user in the virtual space (the start period part) until a peak speed is temporarily reached (the intermediate period part), and then gradually reduces the acceleration toward stop (the end period part). More specifically, the scene that is viewed by the user in the virtual space that is displayed by the display device 1071 of the HMD 107 is gradually accelerated to swiftly change and to temporarily change at the peak speed. Then, the scene that is viewed by the user changes in such a way that the acceleration is gradually reduced toward stop to finally stop changing.

For example, when the stick is tilted forward by the user, acceleration is smoothly performed in the facing direction from the stopped state over about 0.2 seconds. Then, when the stick is returned to neutral due to the user removing the finger, the CPU 101 changes the frame of the image that is viewed by the user in the virtual space in such a way that deceleration is performed smoothly over about 0.2 seconds before stopping. Thanks to such a process, the user is even more unlikely to feel uncomfortable about a change in the image displayed by the display device 1071 and may perceive a natural change. Accordingly, VR sickness in the user in the virtual space may be further prevented.

Additionally, the process in Example 2 and the process in Example 3 may be combined. That is, as the process in Example 2, the CPU 101 brightly displays the movement destination (the rotation direction) of the user in the virtual space, or in other words, the right end of the image (transparency: 100%). The CPU 101 performs display in such a way that the image is gradually darkened from the right end of the image toward the left end, and in such a way that the transparency is 0% at the left end of the image that is the movement origin. At the same time, as the process in Example 3, the CPU 101 changes the speed in a proceeding direction while the user is moving in the virtual space. Alternatively, in the case of changing the direction or the like, the CPU 101 may generate an image where the degree of change is gradually increased in the start period part in the predetermined time range, the degree of change is made the greatest in the intermediate period part, and the degree of change is gradually reduced in the end period part. The CPU 101 may output the generated image to the display device 1071 of the HMD 107. The user may predict the movement destination in the virtual space, and the user is not likely to feel uncomfortable about a change in the image displayed by the display device 1071 and may perceive a natural change. Accordingly, VR sickness in the user in the virtual space may be further prevented.

### FOURTH EXAMPLE

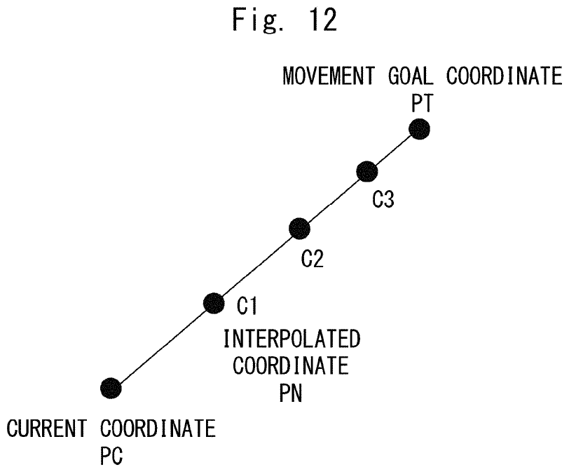

A fourth example (also referred to as “Example 4”) will be described with reference to FIGS. 12 to 14. Examples 1 and 2 illustrate a process related to a change on the horizontal plane or a change in the movement direction or the orientation of the user in the height direction, in the virtual space. In Example 3, when 90-degree rotation of the orientation of the user in the right-hand direction or the left-hand direction in the real space is grasped, rotation of the orientation of the user himself/herself in the virtual space is gradually accelerated. Then, in the illustrated process, the orientation of the user is temporarily rotated at the peak angular velocity, and the angular acceleration of the rotation is gradually reduced to reach the final orientation of the user. Example 4 illustrates a process of changing the movement direction or the orientation of the user in a three-dimensional direction in the virtual space. The process of changing the movement direction or the orientation of the user in the three-dimensional direction includes a process related to movement of the user and a process related to rotation. Other configurations and processes are the same as those in Example 1. Accordingly, Example 1 is assumed to be applied to Example 4 with respect to same processes, and differences will be described below.

FIG. 12 is a diagram illustrating a concept of coordinate interpolation at a time of movement of the user, according to Example 4. In FIG. 12, a current coordinate PC of the user in the virtual space, and a coordinate PT of a movement goal of the user are indicated. The coordinate of the movement goal of the user is a coordinate of the movement destination of the user based on information detected by the accelerometer 1072 of the HMD 107 or information that is input to the controller A 108A or the controller B 108B by the user. In this case, the user is positioned at an interpolated coordinate by the process of spherical linear interpolation by the information processing apparatus 10. The interpolation process is performed for each frame in the predetermined time range. In FIG. 12, C1, C2, and C3 are indicated as interpolated coordinates. Coordinates of the position of the user in the virtual space after a first interpolation process, a second interpolation process, and a third interpolation process are indicated by C1, C2, and C3, respectively. Here, it is assumed that PC indicates a coordinate Vector3(X, Y, Z) of a current position of the user, and that PT indicates a coordinate Vector3(X, Y, Z) of the movement goal of the user. It is also assumed that PN indicates a next coordinate Vector3(X, Y, Z) after interpolation. That is, PC, PT, and PN are all vector values. In the case where PC and PT are updated to latest information every frame, a calculation expression for the coordinate PN after the interpolation process is as follows.

Interpolated coordinate PN=(PT−PC)×attenuation rate

According to the calculation expression, a degree of change in a distance between coordinates is reduced as the current coordinate PC proceeds to C1, from C1 to C2, from C2 to C3, and from C3 to the coordinate PT at the movement goal, as indicated by the interpolated coordinates C1, C2, and C3 in FIG. 12. That is, acceleration of movement of the user is reduced as the current coordinate PC proceeds to C1, from C1 to C2, from C2 to C3, and from C3 to the coordinate PT at the movement goal.

With respect to the change from PC to PT in the predetermined time range, a change from PC to C2 will be specified as a start period part, and a change from C2 to PT will be specified as an end period part. In this case, the control circuit 1011 can be said to generate images that are viewed in the virtual space in such a way that a change per time in the scene in the end period part is a more gradual change than a change per time in the scene in the start period part, and to output the images to the display device 1071 of the HMD 107 in a stepwise manner. The user may thus feel that the change in the scene that is viewed in the virtual space that is displayed by the HMD 107 is the same as a change in a real scene that is viewed by a person. Accordingly, the user is not likely to feel uncomfortable about a change in the image displayed by the display device 1071 and may perceive a natural change, and the user may be prevented from feeling VR sickness.

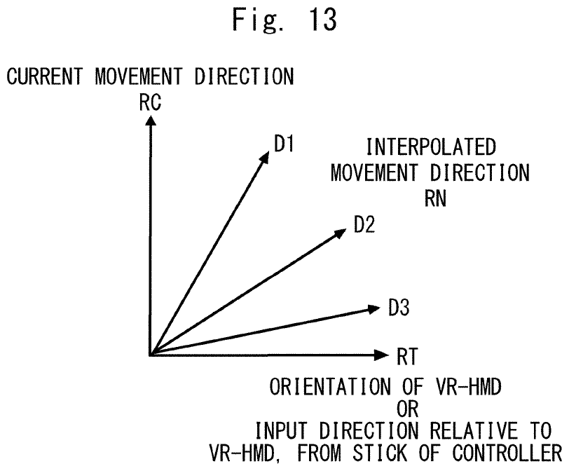

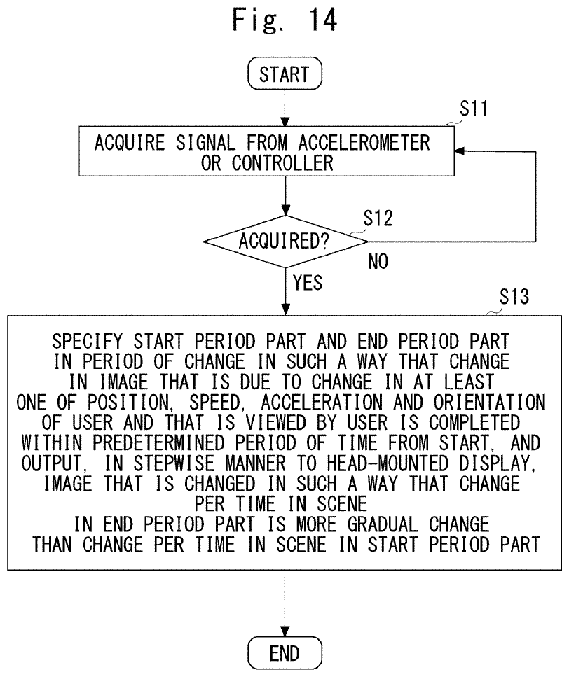

FIG. 13 is a diagram illustrating a concept of interpolation at a time of direction change of the user, according to Example 4. FIG. 13 illustrates a current movement direction RC of the user in the virtual space, and an orientation of the VR-HMD or an input direction RT, from the stick of the controller, relative to the VR-HMD. In this case, the user is moved in the movement direction after interpolation by the process of spherical linear interpolation performed by the information processing apparatus 10. The interpolation process is performed for each frame in the predetermined time range. In FIG. 13, D1, D2, and D3 are indicated as the movement directions after interpolation. Movement directions in which the user moves in the virtual space after a first interpolation process, a second interpolation process, and a third interpolation process are indicated by D1, D2, and D3, respectively. Here, it is assumed that RC indicates a left/right orientation Quaternion(0, 1, 0, W) of the current movement direction of the user, and that RT indicates a left/right orientation Quaternion(0, 1, 0, W) of the VR-HMD. It is also assumed that RN indicates a next left/right orientation Quaternion(0, 1, 0, W) after interpolation. That is, RC, RT, RN are all vector values. In the case where RC and RT are updated to latest information every frame, a calculation expression for the movement direction after the interpolation process is as follows.

Interpolated movement direction RN=(RT−RC)×attenuation rate

According to the calculation expression, a degree of change in an angle of the movement direction is reduced as the current movement direction RC proceeds to D1, from D1 to D2, from D2 to D3, and from D3 to the coordinate RT of the movement goal, as indicated by the interpolated movement directions D1, D2, and D3 in FIG. 13. That is, angular acceleration of rotation of the user is gradually reduced as the current movement direction RC proceeds to D1, from D1 to D2, from D2 to D3, and from D3 to the coordinate RT of the movement goal.

With respect to the change from RC to RT in the predetermined time range, a change from RC to D2 will be specified as a start period part, and a change from D2 to RT will be specified as an end period part. In this case, the control circuit 1011 can be said to generate images that are viewed in the virtual space in such a way that a change per time in the scene in the end period part is a more gradual change than a change per time in the scene in the start period part, and to output the images to the display device 1071 of the HMD 107 in a stepwise manner. The user may thus feel that the change in the scene that is viewed in the virtual space that is displayed by the HMD 107 is the same as a change in a real scene that is viewed by a person. Accordingly, the user is not likely to feel uncomfortable about a change in the image displayed by the display device 1071 and may perceive a natural change, and the user may be prevented from feeling VR sickness.

FIG. 14 is a flowchart illustrating an example of a process, according to Example 4. First, in the process in Example 4, the CPU 101 acquires the detection signal from the accelerometer 1072 or the operation signal from the controller A 108A or the controller B 108B (step S11). The detection signal from the accelerometer 1072 indicates a change in a posture of the user, a change in the orientation, a motion of the user, and the like. The CPU 101 generates an image illustrating a change in the scene in the virtual space caused by movement of the user, based on the detection signal from the accelerometer 1072. Furthermore, the operation signal from the controller A 108A or the controller B 108B is an instruction regarding a movement speed, acceleration, the movement direction and the like of the user in the virtual space, for example. The CPU 101 generates an image illustrating a change in the scene in the virtual space caused by movement of the user, based on the operation signal.

Accordingly, in this process, the CPU 101 determines whether the detection signal from the accelerometer 1072 or the operation signal from the controller A 108A or the controller B 108B is acquired or not (step S12). The detection signal or the operation signal can be said to be an example of information that causes at least one of movement of the position of the user and a change in the orientation of the user in the virtual space. Alternatively, the CPU 101 may be said to perform the process in step S11, as an example of an information acquirer that acquires information that causes at least one of movement of the position of the user and a change in the orientation of the user in the virtual space.

In the case where the detection signal from the accelerometer 1072 or the operation signal from the controller A 108A or the controller B 108B is acquired by the control circuit 1011 (Yes in step S12), the process proceeds to step S13. The control circuit 1011 of the CPU 101 generates an image in the virtual space based on the detection signal or the operation signal that is acquired. In the case where neither the detection signal nor the operation signal is acquired by the control circuit 1011 (No in step S12), the process returns to step S11.

In step S13, the control circuit 1011 generates an image where the scene that is viewed by the user in the virtual space changes in the predetermined time range. More specifically, the control circuit 1011 generates the image by dividing the same into a plurality of frames, in such a way that a change in the image that is viewed by the user, caused by a change in at least one of the position, the speed, the acceleration, and the orientation of the user in the virtual space is completed within a predetermined period of time from start. Furthermore, the control circuit 1011 specifies a start period part and an end period part in a period of change in the predetermined time range. In this case, the control circuit 1011 generates the image that is viewed in the virtual space, in such a way that a change per time in the scene in the end period part is a more gradual change than a change per time in the scene in the start period part. The control circuit 1011 outputs the generated image to the HMD 107 via the wireless I/F 104 in a stepwise manner (step S13). By this process, the control circuit 1011 makes the user view a scene in the virtual space that is changed in a stepwise manner in the predetermined time range. That is, the control circuit 1011 outputs a corresponding frame to the HMD 107 in a predetermined frame period in such a way that the scenes as indicated by PC to PT in FIG. 12 and RC to RT in FIG. 13 are formed in the virtual space. The control circuit 1011 performs the process in step S13, as an example of a control unit that outputs, to the display device, an image in which the scene that is viewed by the user in the virtual space is changed in the predetermined time range, and ends the process.

According to Example 4, the information processing apparatus 10 enables the user to view a scene that is changed in the virtual space in a stepwise manner, based on the detection signal from the accelerometer 1072 or the operation signal from the controller A 108A or the controller B 108B. Accordingly, the scene that is viewed by the user is close to what is predicted by the user or experienced by the user in the real world. Accordingly, VR sickness in the user in the virtual space may be prevented.

The “predetermined time range” in Example 4, or in other words, a time range in which PC changes to PT (RC to RT) is set to 0.1 seconds to 0.3 seconds, for example. This range may be determined based on a speed of reaction of a person to an outside stimulus (such as visual stimulus or auditory stimulus). Accordingly, because the movement direction of the user using the information processing apparatus 10 according to Example 4, the line-of-sight direction, and the scene that is viewed are changed in a stepwise manner in conjunction with one another and according to a reaction speed of a person, VR sickness in the user may be further prevented.

Moreover, the “predetermined time range” in Example 4, or in other words, the time range in which PC changes to PT (RC to RT) is set to substantially 0.2 seconds. This time is a time that is even more suitable, empirically or from ergonomics point of view, to prevent VR sickness in the user. Accordingly, the movement direction of the user using the information processing apparatus 10 according to Example 4, the line-of-sight direction, and the scene that is viewed are changed in a stepwise manner in conjunction with one another and according to an average value of the reaction speed of a person. In this manner, because appropriate acceleration and delay may be applied to the movement of the user in the virtual space by the interpolation process by the information processing apparatus 10, disorder of the autonomic nerves of the user may be prevented. More specifically, at the time of movement, direction change and the like of the user, the information processing apparatus 10 applies “delay time that is felt daily by the brain (about 0.2 seconds)” and “acceleration that is felt daily in the real world”. The information processing apparatus 10 thereby causes the brain of the user to perceive that delays and the like in the movement and a video of VR space are “not different from daily life” and prevents disorder of the autonomic nerves, and VR sickness in the user may thus be further prevented.

<Modification>

In the fourth example, as a concept of interpolation at the time of direction change of the user, a process is illustrated, according to which a change from the coordinate PC to C2 is specified as the start period part, and a change from C2 to PT is specified as the end period part, with respect to the change from PC to PT in the predetermined time range. Furthermore, as a concept of interpolation at the time of direction change of the user, a change from the coordinate RC to D2 is specified as the start period part, and a change from D2 to RT Is specified as the end period part, with respect to the change from RC to RT in the predetermined time range. In a modification, for example, a period from PC to C1 (RC to D1) may be specified as a start period part, a period from C3 to PT (D3 to RT) may be specified as an end period part, and a period from C1 to C3 (D1 to D3) may be specified as an intermediate period part sandwiched between the start period part and the end period part. With respect to a temporal change (angular acceleration) of a temporal change in speed (that is, acceleration) and a temporal change in direction (angular velocity) in these periods, a degree of change (acceleration, angular acceleration) may be gradually increased at first (that is, in the start period part), and a maximum change amount may be temporarily reached in the intermediate period part. Then (that is, in the end period part), the degree of change (acceleration, angular acceleration) may be gradually reduced. In this case, the number of parts into which the period is divided and the degree of change in the present modification are different from those in Example 4 where the change is relatively great at first (that is, in the start period part), and then (that is, in the end period part), the degree of change is gradually reduced.

The control circuit 1011 may interpolate scenes that change stepwise from C1 to C3 (D1 to D3) in such a way that a change per time in the scene in the start period part and the end period part is more gradual than a change per time in the scene in the intermediate period part. Accordingly, also in the present modification, as in Example 4, the user is not likely to feel uncomfortable about a change in the image displayed by the display device 1071 and may perceive a natural change. Therefore, VR sickness in the user in the virtual space may be prevented.

In Examples 1 to 4 described above, a change in the position is an example of a change by which acceleration is gradually increased, and then, acceleration is gradually reduced toward stop, as described above. However, the process by the information processing apparatus 10 is not limited to such a process. The process by the information processing apparatus 10 may be such that acceleration is performed at a constant acceleration in the virtual space, and then, deceleration is performed at a constant acceleration toward stop, for example. In the Example 1, a change in the orientation is an example of a change by which angular acceleration is gradually reduced toward stop. However, the process by the information processing apparatus 10 is not limited to such a process. For example, according to the process by the information processing apparatus 10, deceleration may be gradually performed in the virtual space, at a constant angular acceleration toward stop. In Example 3, a change in the orientation is an example of a change by which the angular acceleration is gradually increased, and then, the angular acceleration is gradually reduced toward stop. However, the process by the information processing apparatus 10 is not limited to such a process. For example, the process by the information processing apparatus 10 may be such that acceleration is performed at a constant angular acceleration in the virtual space, and then, deceleration is gradually performed at a constant angular acceleration toward stop, for example.

Example 1 to Example 4 are merely examples, and the present disclosure may be changed as appropriate within the scope of the disclosure. The processes and/or means described in the present disclosure may be partially extracted and performed or may be performed by being freely combined to the extent that no technical conflict exists.

In Example 1 to Example 4, the information processing apparatus 10 (the CPU 101) acquires the detection signal from the accelerometer 1072 or the operation signal from the controller A 108A or the controller B 108B. Then, the information processing apparatus 10 performs the process of making the user view a scene in the virtual space, as indicated in FIGS. 8, 9, 11, and 14. However, at least one or all of the processes in FIGS. 8, 9, 11, and 14 may be performed by other than the information processing apparatus 10. For example, another information processing apparatus such as a server that can be accessed from the information processing apparatus 10 via the communication I/F 105 and the network N may perform at least one or all of the processes in FIGS. 8, 9, 11, and 14. The information processing apparatus 10 may receive an image that is based on a result of execution by the other information processing apparatus, via the communication I/F 105 and the network N, and may output the image to the HMD 107.

The present disclosure may also be implemented by supplying computer programs for implementing the functions described in the embodiments described above to a computer, and by one or more processors of the computer reading out and executing the programs. Such computer programs may be provided to the computer by a non-transitory computer-readable storage medium that can be connected to a system bus of the computer, or may be provided to the computer through a network. The non-transitory computer-readable storage medium may be any type of disk including magnetic disks (floppy (registered trademark) disks, hard disk drives (HDDs), etc.) and optical disks (CD-ROMs, DVD discs, Blu-ray discs, etc.), read-only memories (ROMs), random access memories (RAMs), erasable programmable read only memories (EPROMs), electrically erasable programmable read-only memories (EEPROMs), magnetic cards, flash memories, optical cards, and any type of medium suitable for storing electronic instructions.

1. An information processing apparatus for forming a virtual space that is viewable by a user by using a display device, the information processing apparatus comprising:
an information acquirer configured to acquire information that causes at least one of movement of a position of the user and a change in an orientation of the user in the virtual space; and
a control circuit configured to output, to the display device, based on the information that is acquired, an image in which a scene being viewed by the user in the virtual space is changed in a predetermined time range according to a speed of reaction of a person to an outside stimulus.

2. The information processing apparatus according to claim 1, wherein
the predetermined time range is divided into at least two period parts including a start period part and an end period part, and
the control circuit outputs the image to the display device in such a way that a change per time in the scene in the end period part is a more gradual change than the change per time in the scene in the start period part.

3. The information processing apparatus according to claim 2, wherein the change per time in the scene is a change that causes a change in an angle of a direction being viewed by the user in the virtual space to be gradually reduced from a start time point of the start period part toward an end time point of the end period part.

4. An information processing apparatus for forming a virtual space that is viewable by a user by using a display device, the information processing apparatus comprising:
an information acquirer configured to acquire information that causes at least one of movement of a position of the user and a change in an orientation of the user in the virtual space; and
a control circuit configured to form an image based on the information that is acquired, in such a way that a movement destination in a movement direction of a line of sight of the user in the virtual space is brighter relative to a movement origin of the line of sight of the user, and to output the image to the display device.

5. The information processing apparatus according to claim 4, wherein the information acquirer acquires the information that causes at least one of the movement of the position of the user and the change in the orientation of the user, based on operation of an operator of the information acquirer by the user.

6. The information processing apparatus according to claim 4, wherein the information acquirer acquires the information that causes at least one of the movement of the position of the user and the change in the orientation of the user, based on detection, by a detector of the information acquirer, of movement of the display device according to movement of an object displayed in the virtual space.

7. The information processing apparatus according to claim 1, wherein
the predetermined time range is divided into at least three period parts including a start period part, an end period part, and an intermediate period part sandwiched between the start period part and the end period part, and
the control circuit outputs the image to the display device in such a way that a change per time in the scene in the start period part and the end period part is a more gradual change than the change per time in the scene in the intermediate period part.

8. The information processing apparatus according to claim 1, wherein the predetermined time range is 0.1 seconds to 0.3 seconds.

9. The information processing apparatus according to claim 1 wherein the predetermined time range is substantially 0.2 seconds.

10. An information processing method implemented by a computer including:
a display device configured to form a virtual space that is viewable by a user,
an information acquirer, and
a control circuit, the information processing method comprising:
acquiring, by the information acquirer, information that causes at least one of movement of a position of the user and a change in an orientation of the user in the virtual space; and
outputting to the display device, by the control circuit, based on the information that is acquired, an image in which a scene being viewed by the user in the virtual space is changed in a predetermined time range according to a speed of reaction of a person to an outside stimulus.

11. An information processing method implemented by a display device configured to form a virtual space that is viewable by a user, and a computer, the information processing method comprising:
acquiring, by the computer, information that causes at least one of movement of a position of the user and a change in an orientation of the user in the virtual space; and
forming, by the computer, an image based on the information that is acquired, in such a way that a movement destination in a movement direction of a line of sight of the user in the virtual space is brighter relative to a movement origin of the line of sight of the user, and to output the image to the display device by the computer.

12. A non-transitory storage medium storing a program for causing a computer that operates in conjunction with a display device configured to form a virtual space that is viewable by a user to:
acquire information that causes at least one of movement of a position of the user and a change in an orientation of the user in the virtual space; and
output, to the display device, based on the information that is acquired, an image in which a scene being viewed by the user in the virtual space is changed in a predetermined time range according to a speed of reaction of a person to an outside stimulus.

13. A non-transitory storage medium storing a program for causing a computer that operates in conjunction with a display device configured to form a virtual space that is viewable by a user to:
acquire information that causes at least one of movement of a position of the user and a change in an orientation of the user in the virtual space; and
form an image based on the information that is acquired, in such a way that a movement destination in a movement direction of a line of sight of the user in the virtual space is brighter relative to a movement origin of the line of sight of the user, and output the image to the display device.
